(19) United States
(12) Patent Application Publication
(10) Pub. No.: US 2025/0289153 A1
(43) Pub. Date: Sep. 18, 2025

(54) OSCILLATING MOTOR CONTROL SYSTEMS

(71) Applicant: WAHL CLIPPER CORPORATION, Sterling, IL (US)

(72) Inventors: Drew Paul MITCHELL, Polo, IL (US); David Joseph TODD, Polo, IL (US)

(21) Appl. No.: 19/076,304

(22) Filed: Mar. 11, 2025

Related U.S. Application Data
(60) Provisional application No. 63/565,102, filed on Mar. 14, 2024.

(51) Int. Cl. B26B 19/12; B26B 19/28; H02K 33/16; H02P 23/00; H02P 23/14; H02P 25/06; H02P 27/08

(52) U.S. Cl. CPC B26B 19/12; B26B 19/282; B26B 19/284; H02K 33/16; H02P 23/0031; H02P 23/14; H02P 25/06; H02P 27/085

(57) ABSTRACT

Some electric hair cutting devices have a stationary blade, a reciprocating blade, and an oscillating motor. Oscillating motors include pivot motors and linear motors. Both motors have a stator, an armature and at least one spring. The armature drives a load such as the reciprocating blade. The armature, the spring and the load have a mechanical resonant frequency. An H-bridge is supplied with pulse width modulated (PWM) signals from a controller and converts direct current from a battery to alternating current having the frequency of the PWM signals. The controller measures the mechanical resonant frequency when power to the motor is turned off and the armature continues to oscillate due to stored energy. The controller adjusts the frequency of the PWM signals to the measured mechanical resonant frequency and stores it in a memory for use the next time the motor is turned on.

This application claims the benefit of U.S. Provisional Application Ser. No. 63/565,102, filed Mar. 14, 2024.

This invention relates to power supplies for oscillating motors having a mechanical resonant frequency such as pivot motors and linear motors, and more particularly, to control systems that measure the mechanical resonant frequency of the load on a pivot motor or linear motor and adjust the power supply frequency accordingly. This invention also relates to oscillating motor control systems that compensate for mechanical changes in mechanical resonant frequency, and electric hair cutting devices having a pivot motor and such control systems.

### BACKGROUND OF THE INVENTION

Oscillating motors including pivot motors and linear motors are known. Oscillating motors have a stator, an armature and a spring system. The motor drives a load. In a vibratory hair clipper, for example, the armature in a pivot motor moves a cutting blade (the load) in a reciprocal fashion by oscillating the armature back and forth. The armature reciprocates with a slight arc. The combination of the motor, spring system and cutting blade have a mechanical resonant frequency. A linear motor does not have a pivot, and the armature oscillates in a straight line, without an arc. The linear motor oscillates, though, and has a mechanical resonant frequency when combined with a load.

With recent improvements in semiconductor and battery technology, vibratory electric hair cutting devices such as hair clippers can be developed that run on direct current provided by rechargeable batteries, as described, for example, in U.S. Pat. No. 12,142,983, issued Nov. 12, 2024, and incorporated herein by reference. In those devices, a power supply converts the direct current from the battery to alternating current using an H-bridge supplied with pulse width modulated (PWM) signals from a controller. The controller can be adjusted at the factory so that the output frequency of the H-bridge adequately matches the mechanical resonant frequency of the pivot motor and blade system.

The mechanical resonant frequency of the system can change over time, particularly if the blades are changed, for example. If the mechanical resonant frequency changes but the driving frequency is not changed, efficiency is decreased, which is undesirable. It is also undesirable to send the device to a service center to adjust the driving frequency of the power supply. Thus, there is a need for power supply control systems for pivot motors, linear motors and the like that automatically adjust the frequency of the power supply near to the mechanical resonant frequency of the motor and its load.

Accordingly, one object of this invention is to provide new and improved control systems for motors that oscillate loads at or near a mechanical resonant frequency.

Another object is to provide new and improved control system for oscillating motor/load combinations that automatically adjust the frequency of the power supply near to or at the mechanical resonant frequency of the motor and load.

Another object is to provide new and improved pivot motor control systems for electric hair cutting devices.

### SUMMARY OF THE INVENTION

In keeping with one aspect of the invention, an electric hair cutting device has a stationary blade, a reciprocating blade, and a pivot motor. The pivot motor has a stator with a plurality of laminations, and a bobbin located in operational relation to the stator. The bobbin has a coil of wire wound around the bobbin. An armature has at least one magnet at one end, a load at another end, and a pivot point between the two ends. The motor also has a spring system. A power supply provides alternating current to the coil, which causes the armature to oscillate at or near the frequency of the alternating current. A linear motor operates in a similar manner without a pivot point. The pivot motor and the linear motor have a mechanical resonant frequency determined primarily by the armature, the spring system and the load, though, and the mechanical resonant frequency can differ from the frequency of the current.

The power supply can be an H-bridge supplied with pulse width modulated (PWM) signals from a controller. The H-bridge converts direct current from a battery to an alternating current having a predetermined frequency when power is provided to the motor. The controller measures the mechanical resonant frequency when power to the motor is turned off and the motor continues to oscillate due to stored energy. The measured frequency is stored in a memory for use the next time the H-bridge is turned on. In this manner, the motor is always operated at or near the mechanical resonant frequency.

### BRIEF DESCRIPTION OF THE DRAWINGS

The above mentioned and other features of this invention and the manner of obtaining them will become more apparent, and the invention itself will be best understood by reference to the following description of an embodiment of the invention taken in conjunction with the accompanying drawings, in which:

FIG. 1 is a perspective view of a hair clipper with the lid removed, having a pivot motor, a power supply and a control system in accordance with the present invention;

FIG. 2 is a plan view of the pivot motor in the hair clipper of FIG. 1;

FIG. 3 is a perspective view of the motor of FIG. 2, showing a sensor and magnet used by the control system to measure the mechanical resonant frequency of the motor/load and adjust the frequency of the power supply accordingly;

FIG. 4 is a perspective view of a linear motor;

FIG. 5 is a schematic diagram of two variations of the control system and power supply for the motors of FIGS. 2 and 4; and

FIG. 6 is a flow chart of the resonant frequency adjustment process used in the motors of FIGS. 2 and 4.

### DETAILED DESCRIPTION

As a preliminary matter, the term “electric hair cutting device” as used herein includes any electric hair cutting device that includes a motor which drives a moving blade to cut hair, including but not limited to hair clippers, hair trimmers, and electric shavers, for human or for animal application. The terms “hair clipper” and “hair trimmer” may be used interchangeably unless otherwise noted, and do not limit the scope or applicability of the invention herein to either particular variant.

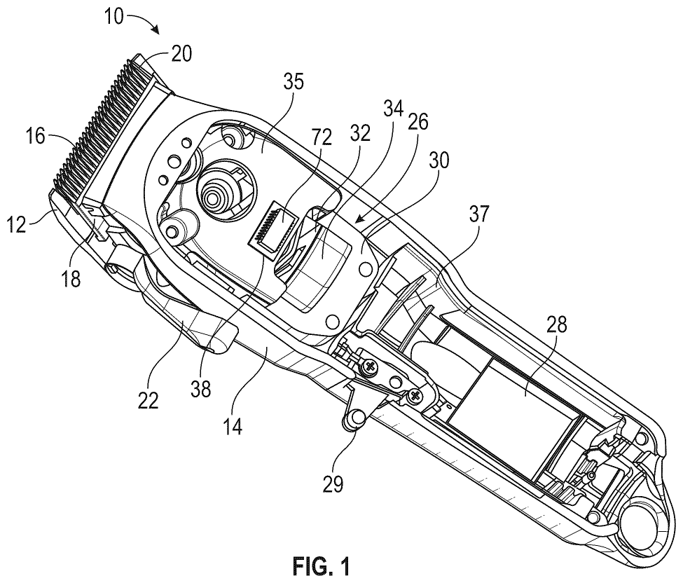

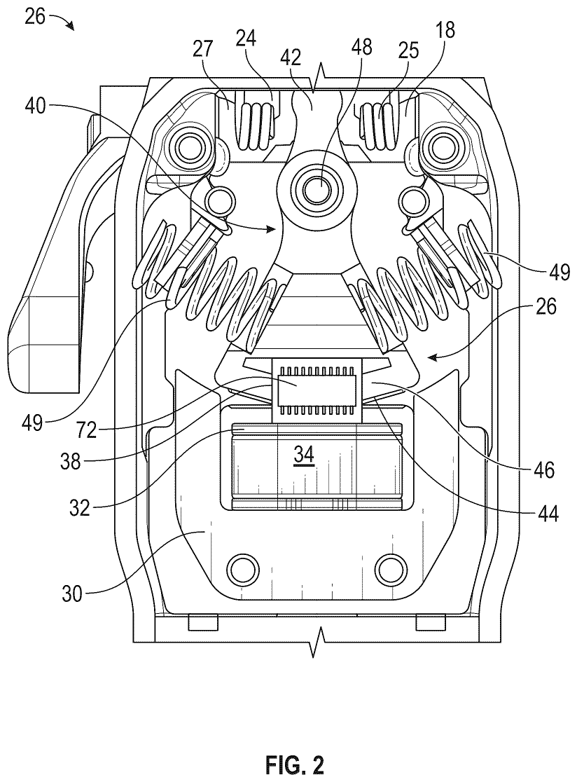

Referring now to FIGS. 1 and 2, a hair clipper 10 has a stationary blade 12 secured to a housing 14. The stationary blade 12 has a first row of cutting teeth 16. A laterally reciprocating or moving blade 18 is operatively secured against the stationary blade 12. The reciprocating blade 18 has a second row of cutting teeth 20 that complement the first row of cutting teeth 16. The distance between the tips of the first and second rows of cutting teeth can be set by and changed using an adjustment lever 22. The stationary cutting teeth 16 and the reciprocating cutting teeth 20 are configured to cut hair when the reciprocating blade oscillates.

A driven element 24 is secured to the reciprocating blade 18. The reciprocating blade 18 is pressed against the stationary blade 12 by a spring 25 that allows the reciprocating blade 18 to oscillate back and forth, causing the cutting teeth to cut hair in operation.

The reciprocating blade 18 is oscillated by a pivot motor 26. Power is provided to the motor 26 by a rechargeable battery 28. A switch 29 controls the motor through a control system, as will be seen.

The motor 26 includes a stator 30 and a bobbin 32. The stator 30 has a plurality of laminations, and the bobbin 32 has a coil of wire 34 wound about the bobbin 32.

A cover plate 35 (FIG. 1) is mounted within a cavity 37 of the clipper housing 14 for locating a sensor board 38 for monitoring the operational stroke of an armature 40.

The armature 40 (FIG. 2) is configured to drive the hair clipper moving blade 18 at a first end 42. The armature 40 has at least one magnet 44 at an opposite end 46, and a pivot point 48. The first end 42 is operatively connected to the reciprocating blade 18. The blade 18 places a load on the motor 26.

The motor 26 has a spring system 49 that stores mechanical energy as it oscillates. In operation, the motor 26, the spring system 49, and the moving blade 18 (the load) have a natural mechanical resonant frequency and stored mechanical energy (kinetic and potential) that decays when power is discontinued.

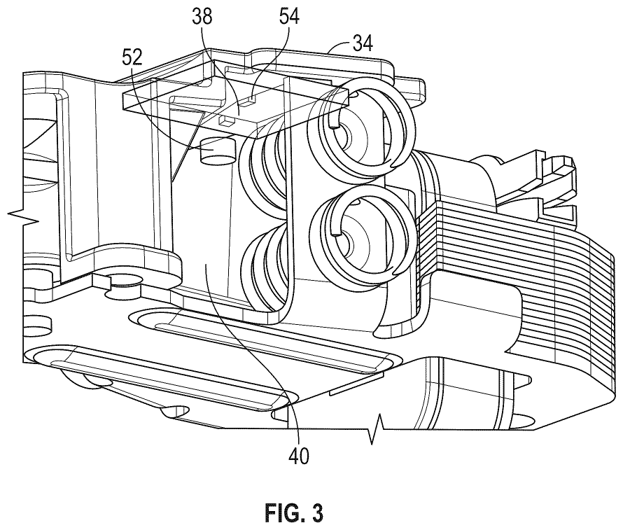

The sensor board 38 (FIG. 3) is secured to the cover plate 34 near the armature 40, and a magnet 52 is secured to the armature 40 close to the sensor board 38. A linear Hall effect sensor 54 on the sensor board 38 is close enough to the magnet 52 to sense changes in the magnetic field caused by movement of the magnet 44 in the armature 40 as the armature 40 oscillates.

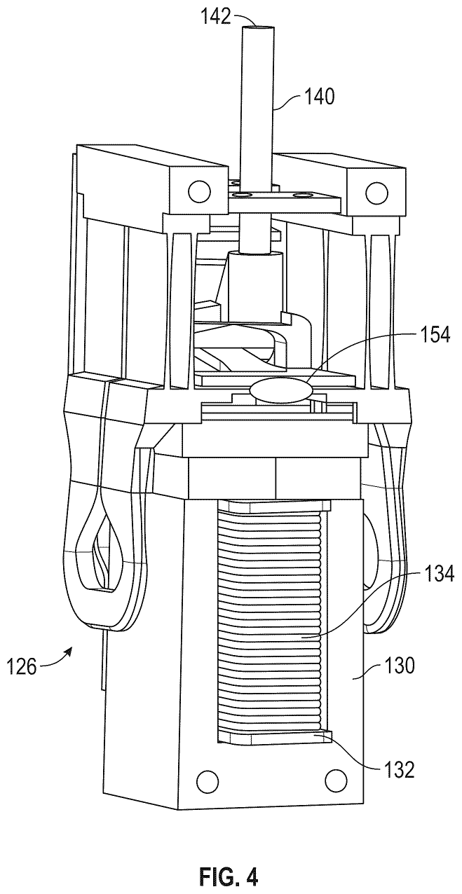

A linear motor 126 is shown in FIG. 4. The components are similar to the components in the pivot motor 26, but there is no pivot point and the armature oscillates in a straight line. The motor 126 has a stator 130, a bobbin 132 and a coil 134. An armature 140 can have a load (not shown) attached at an end 142 or other suitable location as desired. A sensor can be provided to measure the mechanical resonant frequency of the motor/load combination, as with the pivot motor, or the control system can use a back-EMF method, which will be described. Hereafter, reference numerals will refer to the components of the pivot motor 26, recognizing the correspondence of components in the linear motor 126.

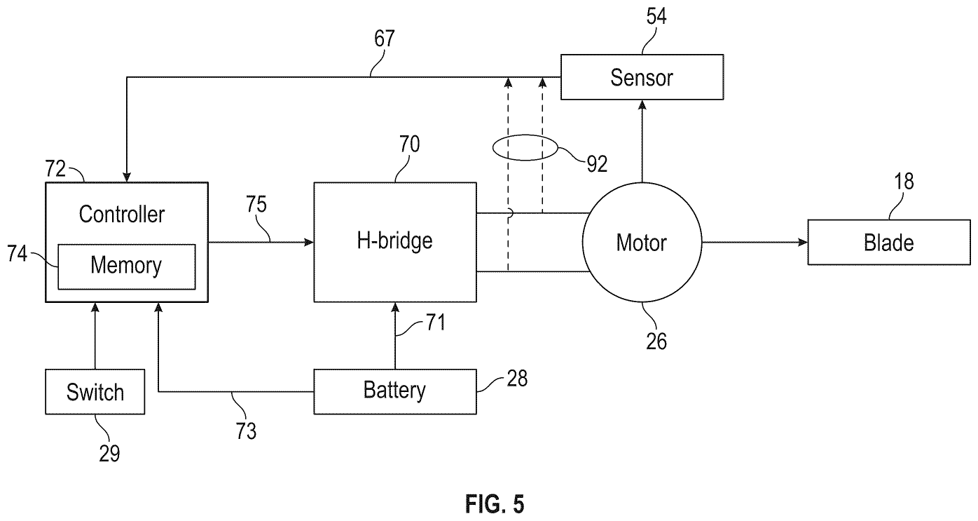

Referring now to FIG. 5, the battery 28 supplies current to an H-bridge 70 through a line 71. The H-bridge 70 in turn powers the motor 26, which in turn oscillates the cutting blade 18.

The H-bridge 70 converts the direct current from the battery 28 into an AC square wave of a desired frequency, which is preferably at or near the mechanical resonant frequency of the motor 26 in combination with the blade 18. The frequency of the H-bridge 70 is determined by a controller 72 and is stored in a memory 74.

In commercial products it is sometimes desirable to set the frequency of the power supply between +5% and −5% of the mechanical resonant frequency. For purposes of this description, “at” the desired frequency should be understood to include frequencies between +5% and −5% of the mechanical resonant frequency.

The control system includes the controller 72, the sensor 54 (if present) and the memory 74. The controller 72 is powered by the battery 28 through a line 73. The controller 72 has power continuously unless the battery is discharged. When the switch 29 is closed, the controller 72 reads the set frequency from the memory 74 and sends pulse modulated signals to the H-bridge 70 through the line 75 at that frequency. The H-bridge 70 drives the motor 26 at that frequency as well.

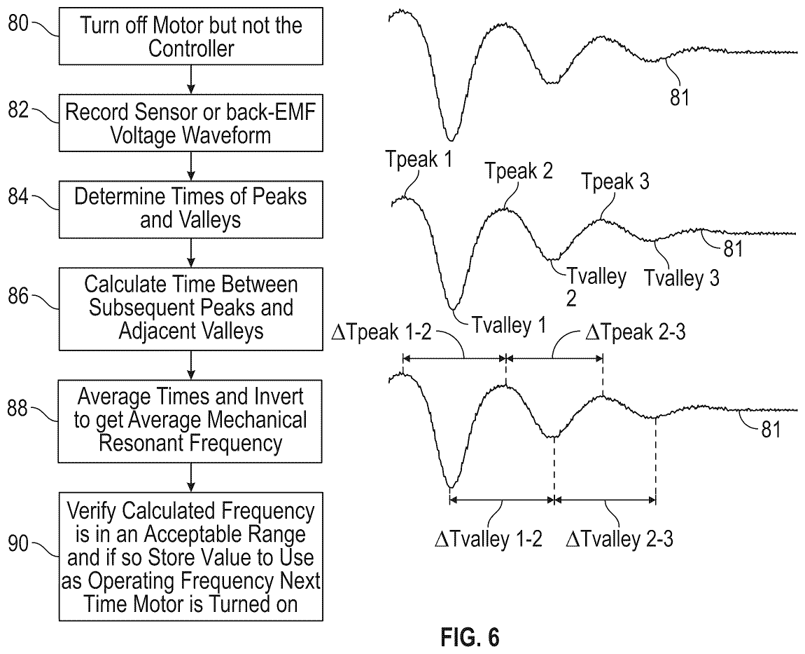

When the switch 29 is opened, the controller 72 continues to have power. The controller 72 is programmed to determine the mechanical resonant frequency of the motor 26 by following the algorithm in FIG. 6. When the motor is turned off at step 80, the controller 72 records the sensor voltage waveform at step 82. Waveform 81 is an exemplary output of the sensor 54, indicating that the armature 40 is oscillating back and forth without power, the oscillations are at a nearly constant frequency, and the signal is decaying as the armature loses energy.

The controller 72 finds the decaying peaks Tpeak1, Tpeak2 and Tpeak3 and valleys Tvalley1, Tvalley2 and Tvalley3 of the waveform 81 in step 84. The time intervals between adjacent peaks (ΔTpeak1−2 and ΔTpeak2−3) and valleys (ΔTvalley1−2 and ΔTvalley2−3) are calculated in step 86. Average time intervals (seconds) are calculated and inverted (one/seconds) to determine a measured mechanical resonant frequency of the motor in step 88. If the measured frequency is in an acceptable range, the value is stored in the memory 74 at step 90. The newly calculated measured frequency is used when the motor 26 is turned back on.

Dotted lines 92 in FIG. 5 describe another way to measure mechanical resonant frequency when power is turned off. When the motor 26 is turned off, the continued vibration of the motor and load generates a back-EMF voltage 81 that is fed back to the controller 72 and analyzed in step 82 of the algorithm in FIG. 6. The sensor 54 is then unnecessary, and can be eliminated for purposes of measuring mechanical resonant frequency if desired.

Advantages of the invention are now apparent. More efficient, cooler running oscillating motors are produced by adjusting the driving/output frequency of the power supply to the mechanical resonant frequency of the motor. If the blades (or other load) wear, are replaced, or the mechanical resonant frequency changes for any reason over time, the frequency of the power supply is changed accordingly.

While the principles of the invention have been described above in connection with specific apparatus and applications, it is to be understood that this description is made only by way of example and not as a limitation on the scope of the invention.

1. An electric hair cutting device comprising:
a stationary blade and a reciprocating blade configured to cut hair when the reciprocating blade oscillates,
a motor having an oscillating armature configured for driving the reciprocating blade, a stator and at least one spring,
an alternating current power supply having an adjustable output frequency, the power supply sending electrical current to the stator, causing the armature to oscillate, and
a controller that measures the mechanical resonant frequency of the motor and reciprocating blade combination when power is turned off, the controller storing the mechanical resonant frequency in a memory and adjusting the output frequency of the power supply to within +5% and −5% of the mechanical resonant frequency of the motor and reciprocating blade combination.

2. The electric hair cutting device of claim 1 wherein the armature oscillates linearly.

3. The electric hair cutting device of claim 1 wherein the armature oscillates around a pivot point.

4. The electric hair cutting device of claim 1 further comprising:
a sensor that senses motion of the armature and generates signals reflecting a frequency of the motor when the motor is not powered, the signals being sent to the controller,
the controller using the sensor signals to calculate the measured mechanical resonant frequency of the motor when the motor is not powered,
the controller storing the measured mechanical resonant frequency in the memory.

5. The electric hair cutting device of claim 4 comprising a magnet mounted on the armature, the sensor detecting motion of the armature from changes in the magnetic field of the magnet as the armature moves towards and away from the sensor.

6. The electric hair cutting device of claim 4 wherein the controller, the memory and the sensor comprise a control system for the motor when the motor is turned on, wherein further the control system is powered when the motor is turned off, and when the motor has been turned off, the control system:
records the sensor output during a decaying motion of the armature, the output being a waveform having a plurality of decaying peaks and valleys,
determines the times of the peaks and valleys of the waveform,
calculates time intervals between consecutive peaks and valleys,
averages the time intervals and inverts the time intervals to calculate an average mechanical resonant frequency,
verifies that the calculated average mechanical resonant frequency is in an acceptable range, and
stores the calculated average mechanical resonant frequency in the memory as the measured mechanical resonant frequency for use as the operating frequency of the H-bridge the next time the motor is turned on.

7. The electric hair cutting device of claim 1 wherein back-EMF voltage generated by the motor is fed to the controller when power is turned off, and the controller uses the back-EMF voltage to calculate the measured mechanical resonant frequency of the motor when the motor is not powered.

8. The electric hair cutting device of claim 7 wherein the controller and the memory comprise a control system for the motor when the motor is turned on, wherein further the control system is powered when the motor is turned off, and when the motor has been turned off, the control system:
records the back-EMF voltage during a decaying motion of the armature, the output being a waveform having a plurality of decaying peaks and valleys,
determines the times of the peaks and valleys of the waveform,
calculates time intervals between consecutive peaks and valleys,
averages the time intervals and inverts the time intervals to calculate an average mechanical resonant frequency,
verifies that the calculated average mechanical resonant frequency is in an acceptable range, and
stores the calculated average mechanical resonant frequency in the memory as the measured mechanical resonant frequency for use as the operating frequency of the H-bridge the next time the motor is turned on.

9. An electric hair cutting device comprising:
a stationary blade and a reciprocating blade configured to cut hair when the reciprocating blade oscillates,
a pivot motor having
a stator with a plurality of laminations, a bobbin located in operational relation to the stator and a coil of wire wound around the bobbin;
an armature configured for driving the reciprocating blade at one end of the armature, the armature having at least one magnet at an opposite end; and
a pivot point between the one end and the opposite end; and
at least one spring;
the pivot motor having a mechanical resonant frequency determined by the armature, the spring and the reciprocating blade;
the electric hair cutting device further having
a battery and an H-bridge supplied with pulse width modulated (PWM) signals from a controller, the H-bridge converting direct current from the battery to an alternating current having a predetermined frequency when power is provided to the pivot motor,
wherein the controller measures the mechanical resonant frequency of the pivot motor, the reciprocating blade and the spring when power to the pivot motor is turned off and the pivot motor continues to pivot due to stored energy, and stores the measured mechanical resonant frequency in a memory, the measured mechanical resonant frequency being used to control the H-bridge the next time the pivot motor is powered.
